(19) United States
(12) Patent Application Publication
(10) Pub. No.: US 2008/0257102 A1
(43) Pub. Date: Oct. 23, 2008

(54) MECHANICALLY RETAINED MOTORCYCLE HANDLEBAR GRIPS

(76) Inventor: William Packer, Essex (GB)

Correspondence Address: Christopher P. Harris;Tarolli, Sundheim, Covell & Tummino, L.L.P., Suite 1700, 1300 East Ninth Street, Cleveland, OH, 44114, US

(21) Appl. No.: 12/105,513

(22) Filed: Apr. 18, 2008

Related U.S. Application Data
(60) Provisional application No. 60/913,103, filed on Apr. 20, 2007.

(51) Int. Cl. B62K 21/26

(52) U.S. Cl. 74/551.9

(57) ABSTRACT

A motorcycle handlebar grip 4 which attaches using a positive mechanical method, to a fixed anchorage point 1 which is secured to the motorcycles handlebar 3. The right hand side of the handlebar 3 uses the throttle rotor 1 to attach to, which is retained as part of the motorcycles throttle assemble, and therefore fixed securely. The left hand side features a clamp in place of the throttle rotor 1, which effectively replaces the throttle assembly as the fixed anchorage point, the grip attaching in the same way.

This invention relates to the handlebar grips fitted to motorcycles, and the necessity to replace them regularly.

The grips fitted to motorcycle handlebars are important to the comfort of the rider, to help dull vibration and therefore aid in controlling the motorcycle. The qualities required from a handlebar grip means they are a soft compound and therefore they do wear away with use and require replacing regularly. This applies to all types of grips, fitted to all types of motorcycles. Those used for sport or on racing motorcycles are particularly susceptible to wearing away quickly. Handlebar grips are attached using the elastic properties of their material, and glue. This can make replacing them awkward and time consuming.

This invention proposes motorcycle handlebar grips which are retained in position on the handlebar by means of a positive, mechanical fit.

The mechanical fixing of the handlebar grip ensures a replacement can be fitted quickly and easily employing a mechanical procedure to achieve a positive fit. The grip acts as part of an assembly once fitted, by becoming positively fixed to an anchorage point on the motorcycle's handlebar. Once fitted the grip becomes an integral part of the assembly. By using a positive, mechanical means of attachment, the grip is secure yet can be replaced quickly.

An example of the invention is now described using the following drawings for reference.

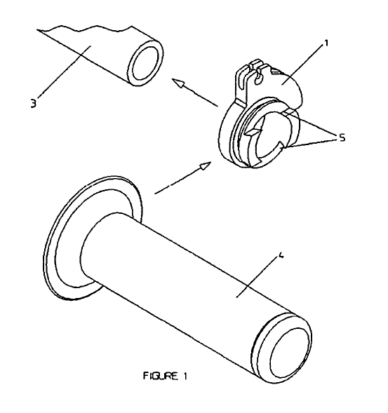

FIG. 1 shows an assembly of the right hand side product. This drawing shows how the product will be assembled on the throttle side of the motorcycle.

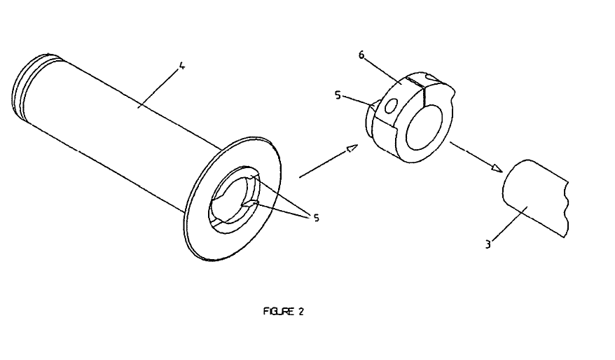

FIG. 2 shown an assembly of the left hand side product. This drawing shows how the product will be assembled on the other side of the handlebar, where there is no throttle.

Referring to FIG. 1 of the drawings.

On this side of the motorcycle the throttle rotor 1 acts as part of the motorcycles existing throttle assembly (not shown). Once fitted it is inside the throttle and is therefore fixed to the handlebar 3. The grip tube 4 is a tube covered with the moulded rubber cushioning which is the grip's contact area with the rider's hand. It is mechanically locked into the throttle rotor 1 by the positive locking taper 5. Once in place, the grip tube 4 acts integrally as part of the assembly. It can be seen from FIG. 1 that to detach the grip tube 4 from the assembly, it is necessary to slide the throttle rotor 1 (assembled inside the throttle) to the end of the handlebar 3. This allows the positive locking taper 5 to be released by parting in the opposing direction.

Referring to FIG. 2 of the drawings.

The left hand side of the handlebar 3 requires the clamp 6 to act as the anchor point. The clamp 6 is mounted to the handlebar, allowing the grip tube 4 to be attached to it using the positive locking taper 5. It can be seen from FIG. 2 that to detach the grip tube 4 from the assembly, it is necessary to slide the clamp 6 to the end of the handlebar 3. This allows the positive locking taper 5 to be released by parting in the opposing direction.

1. A motorcycle handlebar grip that is retained in position on the handlebar by a positive mechanical fitting method.

2. A handlebar grip according to claim 1 which consists essentially of a solid tube with rubber cushioning exposed to the riders hand.

3. A handlebar grip according to claim 1 which locks to an anchorage point which is fixed to the handlebar, thus allowing the grip area to be replaced independently.

4. A handlebar grip according to claim 1 which once fitted to the anchorage point acts as an integral part of the assembly, and can only be separated by reversing the assembly procedure.
